(19) United States
(12) Patent Application Publication
(10) Pub. No.: US 2021/0377847 A1
(43) Pub. Date: Dec. 2, 2021

(54) COMMUNICATION METHOD, TERMINAL DEVICE, AND CORE NETWORK DEVICE

(71) Applicant: HUAWEI TECHNOLOGIES CO., LTD., Shenzhen (CN)

(72) Inventors: Shuigen YANG, Shanghai (CN); Yinghao JIN, Shanghai (CN); Feng HAN, Shanghai (CN); Wei TAN, Shanghai (CN)

(21) Appl. No.: 17/401,951

(22) Filed: Aug. 13, 2021

Related U.S. Application Data
(63) Continuation of application No. PCT/CN2020/074722, filed on Feb. 11, 2020.

(30) Foreign Application Priority Data
Feb. 15, 2019 (CN) 201910118823.7

(51) Int. Cl. H04W 48/16; H04W 60/00; H04W 48/08; H04W 76/10

(52) U.S. Cl. CPC H04W 48/16; H04W 76/10; H04W 48/08; H04W 60/00

(57) ABSTRACT

Embodiments of this application disclose a communication method, a terminal device, and a core network device. The method includes: The terminal device sends, through a radio access network device, a registration request message including first network slice information to the core network device. The first network slice information is information about a first network slice corresponding to a PDU session that the terminal device expects to establish. The terminal device receives, through the radio access network device, a registration accept message that is sent by the core network device and that includes information about a first registration area allocated to the terminal device and second network slice information, the second network slice information is information about a second network slice that is allowed to be used by the terminal device in the first registration area, and the second network slice information includes the first network slice information.

### CROSS-REFERENCE TO RELATED APPLICATIONS

This application is a continuation of International Application No. PCT/CN2020/074722, filed on Feb. 11, 2020, which claims priority to Chinese Patent Application No. 201910118823.7 filed on Feb. 15, 2019. The disclosures of the aforementioned applications are hereby incorporated by reference in their entireties.

### TECHNICAL FIELD

This application relates to the field of communications technologies, and in particular, to a wireless communication method, a terminal device, and a core network device.

### BACKGROUND

A concept of a network slice is introduced into a 5th generation (5G) communication system, and in a network slicing technology, one physical network can be divided into a plurality of virtual networks. A virtual network is considered as a “network slice”, and network slices are independent of each other. Different sessions in one terminal device may need network slices corresponding to the sessions to provide a service. In actual application, the terminal device needs to send requested network slice information to a core network device, and the core network device feeds back allowed network slice information to the terminal device. If the network slice information requested by the terminal device is not in the allowed network slice information, the terminal device cannot use the requested network slice information. This manner limits a quantity or types of network slices that can be used by the terminal device in a coverage area of a current radio access network device, and also limits a type of a PDU session that can be established by the terminal device. Consequently, a requirement that the terminal device performs communication by using the network slice cannot be met.

In this case, how to better meet the requirement that the terminal device performs communication by using the network slice is a problem that needs to be solved.

### SUMMARY

Embodiments of this application provide a wireless communication method, a terminal device, and a core network device, to better meet a requirement that the terminal device performs communication by using a network slice.

According to a first aspect, an embodiment of this application provides a communication method, including:

A terminal device sends, through a radio access network device, a registration request message including first network slice information to a core network device. The first network slice information is information about a first network slice corresponding to a PDU session that the terminal device expects to establish. The terminal device receives, through the radio access network device, a registration receiving message sent by the core network device, where the registration receiving message includes information about a first registration area allocated to the terminal device and second network slice information, the second network slice information is information about a second network slice that is allowed to be used by the terminal device in the first registration area, and the second network slice information includes the first network slice information.

In the first aspect, the terminal device may send, to the core network device, information about a network slice corresponding to the PDU session that is expected to be established. The core network device may reallocate an RA to the terminal device based on the information about the network slice corresponding to the PDU session that the terminal device expects to establish. In addition, the reallocated RA can support network slices corresponding to all sessions that the terminal device expects to establish. In this way, a quantity or types of network slices that can be used by the terminal device in a coverage area of a current radio access network device is/are expanded, and a type of a PDU session that can be established by the terminal device is also increased, thereby meeting, to a greater extent, a requirement that the terminal device performs communication by using the network slice.

Optionally, names of the registration request message and the registration receiving message are not limited in this application.

With reference to the first aspect, in a possible implementation, the registration request message includes fourth network slice information, and the fourth network slice information is requested NSSAI. The requested NSSAI is used to indicate a fourth network slice provided by the terminal device to a serving public land mobile network in a registration process. The first network slice is a subset or a complete set of the fourth network slice. For example, the fourth network slice includes a network slice 1, a network slice 2, and a network slice 3, and the first network slice may be the network slice 2. The registration request message needs to carry the fourth network slice information and the first network slice information.

With reference to the first aspect, in a possible implementation, the registration request message further includes slice availability information, and the slice availability information includes information about whether the first network slice is available in a tracking area included in a historically allocated second registration area. After the slice availability information is sent to the core network device, the core network device may allocate the first RA to the terminal device based on the slice availability information, so that the terminal device may use the first network slice in the first RA.

With reference to the first aspect, in a possible implementation, the first network slice is a network slice that is supported by the radio access network device and that corresponds to the PDU session that the terminal device expects to establish. In this way, expected first network slice information is more easily included in second network slice information allowed by the core network device, and the terminal device does not need to include, in the registration request message, information about a network slice that is not supported by the radio access network device, thereby reducing transmission overheads caused because the terminal device includes, in the registration request message, the information that is not supported by the radio access network device.

With reference to the first aspect, in a possible implementation, before the terminal device sends the registration request message to the core network device, the method further includes obtaining third network slice information of a third network slice supported by the radio access network device. A specific implementation process may be: The terminal device sends a first message to the radio access network device, where the first message is used to obtain third network slice information of the third network slice supported by the radio access network device. The terminal device receives a second message sent by the radio access network device, where the second message includes the third network slice information.

Optionally, the first message is a radio resource control RRC system information request message, the second message is a system information message, and the system information message includes the third network slice information. In this case, optionally, the first message may carry a requested system information block identifier, the requested system information block identifier is used to obtain the third network slice information, and the requested system information block identifier is used to indicate information obtained through the first message. Alternatively, optionally, the first message may carry first indication information, the first indication information is used to obtain the third network slice information of the third network slice supported by the radio access network device, and the first indication information is used to indicate information obtained through the first message.

Optionally, the first message is a random access preamble message, and the second message is a system information message. In this case, optionally, the first message may carry a requested system information block identifier, the requested system information block identifier is used to obtain the third network slice information, and the requested system information block identifier is used to indicate information obtained through the first message. Alternatively, optionally, the first message may carry second indication information, the second indication information is used to obtain the third network slice information of the third network slice supported by the radio access network device, and the second indication information is used to indicate information obtained through the first message.

Optionally, the first message is a radio resource control RRC request message, and the second message is an RRC response message. In this case, optionally, the first message may carry third indication information, the third indication information is used to obtain the third network slice information of the third network slice supported by the radio access network device, and the third indication information is used to indicate information obtained through the first message.

With reference to the first aspect, in a possible implementation, the first network slice information includes at least one piece of single network slice selection assistance information S-NSSAI.

According to a second aspect, an embodiment of this application provides a communication method, including:

A core network device receives, through a radio access network device, a registration request message that is sent by a terminal device and that includes first network slice information. The first network slice information is information about a first network slice corresponding to a PDU session that the terminal device expects to establish. The core network device allocates a first registration area to the terminal device based on the registration request message, where the first registration area supports at least a second network slice, and the second network slice is a network slice that is allowed to be used by the terminal device in the first registration area. The core network device sends a registration receiving message to the terminal device through the radio access network device, where the registration receiving message includes information about the first registration area and second network slice information of the second network slice, and the second network slice information includes the first network slice information.

In the second aspect, the core network device may reallocate an RA to the terminal device based on information about a network slice corresponding to the PDU session that the terminal device expects to establish. In addition, the reallocated RA can support network slices corresponding to all sessions that the terminal device expects to establish. In this way, a quantity or types of network slices that can be used by the terminal device in a coverage area of a current radio access network device is/are expanded, and a type of a PDU session that can be established by the terminal device is also increased, thereby meeting, to a greater extent, a requirement that the terminal device performs communication by using the network slice.

With reference to the second aspect, in a possible implementation, the first registration area includes at least one tracking area, each of the at least one tracking area supports the first network slice, and the at least one tracking area is determined based on a network slice supported by each of a plurality of tracking areas and the first network slice information.

With reference to the second aspect, in a possible implementation, the registration request message further includes slice availability information, and the slice availability information includes information about whether the first network slice is available in a tracking area included in a historically allocated second registration area. The core network device may allocate the first RA to the terminal device based on the slice availability information, so that the terminal device may use the first network slice in the first RA.

With reference to the second aspect, in a possible implementation, the first registration area includes at least one tracking area, each of the at least one tracking area supports the first network slice, and the at least one tracking area is determined based on the slice availability information and the first network slice information.

With reference to the second aspect, in a possible implementation, the first network slice is a network slice that is supported by the radio access network device and that corresponds to the PDU session that the terminal device expects to establish. In this way, expected first network slice information is more easily included in second network slice information allowed by the core network device, and the terminal device does not need to include, in the registration request message, information about a network slice that is not supported by the radio access network device, thereby reducing transmission overheads caused because the terminal device includes, in the registration request message, the information that is not supported by the radio access network device.

With reference to the second aspect, in a possible implementation, the first network slice information includes at least one piece of single network slice selection assistance information S-NSSAI.

According to a third aspect, an embodiment of this application provides a communication method, including:

A terminal device sends a first message to a radio access network device, where the first message is used to obtain third network slice information of a third network slice supported by the radio access network device. The terminal device receives a second message sent by the radio access network device, where the second message includes the third network slice information.

Optionally, the first message is a radio resource control RRC system information request message, the second message is a system information message, and the system information message includes the third network slice information. In this case, optionally, the first message may carry a requested system information block identifier, the requested system information block identifier is used to obtain the third network slice information, and the requested system information block identifier is used to indicate information obtained through the first message. Alternatively, optionally, the first message may carry first indication information, the first indication information is used to obtain the third network slice information of the third network slice supported by the radio access network device, and the first indication information is used to indicate information obtained through the first message.

Optionally, the first message is a random access preamble message, and the second message is a system information message. In this case, optionally, the first message may carry a requested system information block identifier, the requested system information block identifier is used to obtain the third network slice information, and the requested system information block identifier is used to indicate information obtained through the first message. Alternatively, optionally, the first message may carry second indication information, the second indication information is used to obtain the third network slice information of the third network slice supported by the radio access network device, and the second indication information is used to indicate information obtained through the first message.

Optionally, the first message is a radio resource control RRC request message, and the second message is an RRC response message. In this case, optionally, the first message may carry third indication information, the third indication information is used to obtain the third network slice information of the third network slice supported by the radio access network device, and the third indication information is used to indicate information obtained through the first message.

In the third aspect, the first message or the second message may be a message existing in a current standard, and the existing message is used to implement a solution in the third aspect. Alternatively, the first message or the second message may be a new message.

Optionally, the terminal device may further perform a registration procedure. Specifically, the terminal device needs to perform the registration procedure in several cases. For example, in a mobility registration update scenario, the terminal device performs the registration procedure; in a periodic registration update scenario, the terminal device performs the registration procedure; in an emergency registration update scenario, the terminal device performs the registration procedure. For a specific implementation process of performing the registration procedure, refer to the specific descriptions of the first aspect and the second aspect.

In the third aspect, the terminal device may obtain the third network slice information of the third network slice supported by the radio access network device, so that the terminal device determines, in a coverage area of a current radio access network device, a quantity or types of network slices supported by the radio access network device.

According to a fourth aspect, an embodiment of this application provides a communication method, including:

A radio access network device receives a first message sent by a terminal device, where the first message is used to obtain third network slice information of a third network slice supported by the radio access network device. The radio access network device sends a second message to the terminal device, where the second message includes the third network slice information.

Optionally, the first message is a radio resource control RRC system information request message, the second message is a system information message, and the system information message includes the third network slice information. In this case, optionally, the first message may carry a requested system information block identifier, the requested system information block identifier is used to obtain the third network slice information, and the requested system information block identifier is used to indicate information obtained through the first message. Alternatively, optionally, the first message may carry first indication information, the first indication information is used to obtain the third network slice information of the third network slice supported by the radio access network device, and the first indication information is used to indicate information obtained through the first message.

Optionally, the first message is a random access preamble message, and the second message is a system information message. In this case, optionally, the first message may carry a requested system information block identifier, the requested system information block identifier is used to obtain the third network slice information, and the requested system information block identifier is used to indicate information obtained through the first message. Alternatively, optionally, the first message may carry second indication information, the second indication information is used to obtain the third network slice information of the third network slice supported by the radio access network device, and the second indication information is used to indicate information obtained through the first message.

Optionally, the first message is a radio resource control RRC request message, and the second message is an RRC response message. In this case, optionally, the first message may carry third indication information, the third indication information is used to obtain the third network slice information of the third network slice supported by the radio access network device, and the third indication information is used to indicate information obtained through the first message.

In the fourth aspect, the radio access network device may send the third network slice information of the third network slice to the terminal device, so that the terminal device determines, in a coverage area of a current radio access network device, a quantity or types of network slices supported by the radio access network device.

According to a fifth aspect, an embodiment of this application provides a terminal device, including:

a sending module, configured to send a registration request message to a core network device through a radio access network device, where the registration request message includes first network slice information, and the first network slice information is information about a first network slice corresponding to a PDU session that the terminal device expects to establish; and

a receiving module, configured to receive, through the radio access network device, a registration receiving message sent by the core network device, where the registration receiving message includes information about a first registration area allocated to the terminal device and second network slice information, the second network slice information is information about a second network slice that is allowed to be used by the terminal device in the first registration area, and

the second network slice information includes the first network slice information.

Optionally, the terminal device may further implement the method performed in any one of the first aspect and the possible implementations of the first aspect.

According to a sixth aspect, an embodiment of this application provides a core network device, including:

a receiving module, configured to receive a registration request message sent by a terminal device, where the registration request message includes first network slice information, and the first network slice information is information about a first network slice corresponding to a PDU session that the terminal device expects to establish;

a processing module, configured to allocate a first registration area to the terminal device based on the registration request message, where the first registration area supports at least a second network slice, and the second network slice is a network slice that is allowed to be used by the terminal device in the first registration area; and

a sending module, configured to send a registration receiving message to the terminal device, where the registration receiving message includes information about the first registration area and second network slice information of the second network slice, and

the second network slice information includes the first network slice information.

Optionally, the core network device may further implement the method performed in any one of the second aspect and the possible implementations of the second aspect.

According to a seventh aspect, an embodiment of this application provides a terminal device, including:

a sending module, configured to send a first message to a radio access network device, where the first message is used to obtain third network slice information of a third network slice supported by the radio access network device; and

a receiving module, configured to receive a second message sent by the radio access network device, where the second message includes the third network slice information.

Optionally, the terminal device may further implement the method performed in any one of the third aspect and the possible implementations of the third aspect.

According to an eighth aspect, an embodiment of this application provides a radio access network device, including:

a receiving module 1101, configured to receive a first message sent by a terminal device, where the first message is used to obtain third network slice information of a third network slice supported by a radio access network device; and

a sending module 1102, configured to send a second message to the terminal device, where the second message includes the third network slice information.

Optionally, the radio access network device may further implement the method performed in any one of the fourth aspect and the possible implementations of the fourth aspect.

According to a ninth aspect, an embodiment of this application provides a communication apparatus. The communication apparatus may be the terminal device in the foregoing device designs, or may be a chip disposed in the terminal device. The communication apparatus includes: a processor, a memory, and a transceiver.

The transceiver is configured to receive and send a message.

The memory is configured to store instructions.

The processor is configured to execute the instructions stored in the memory. When the processor executes the instructions stored in the memory, the communication apparatus is enabled to perform the method performed in any one of the first aspect, the third aspect, and the possible implementations of the first aspect and the third aspect.

According to a tenth aspect, an embodiment of this application provides a communication apparatus. The communication apparatus may be the core network device in the foregoing device designs, or may be a chip disposed in the core network device. The communication apparatus includes: a processor, a memory, and a transceiver.

The transceiver is configured to receive and send a message.

The memory is configured to store instructions.

The processor is configured to execute the instructions stored in the memory. When the processor executes the instructions stored in the memory, the communication apparatus is enabled to perform the method performed in any one of the second aspect and the possible implementations of the second aspect.

According to an eleventh aspect, an embodiment of this application provides a communication apparatus. The communication apparatus may be the radio access network device in the foregoing device designs, or may be a chip disposed in the radio access network device. The communication apparatus includes: a processor, a memory, and a transceiver.

The transceiver is configured to receive and send a message.

The memory is configured to store instructions.

The processor is configured to execute the instructions stored in the memory. When the processor executes the instructions stored in the memory, the communication apparatus is enabled to perform the method performed in any one of the fourth aspect and the possible implementations of the fourth aspect.

According to a twelfth aspect, an embodiment of this application provides a computer program product. The computer program product includes: computer program code. When the computer program code is run on a computer, the computer is enabled to perform the method in any one of the first aspect, the third aspect, and the possible implementations of the first aspect and the third aspect.

According to a thirteenth aspect, an embodiment of this application provides a computer program product. The computer program product includes: computer program code. When the computer program code is run on a computer, the computer is enabled to perform the method in any one of the second aspect and the possible implementations of the second aspect.

According to a fourteenth aspect, an embodiment of this application provides a computer program product. The computer program product includes: computer program code. When the computer program code is run on a computer, the computer is enabled to perform the method in any one of the fourth aspect and the possible implementations of the fourth aspect.

According to a fifteenth aspect, an embodiment of this application provides a readable storage medium. The readable storage medium is configured to store instructions, to implement any one of the first aspect, the third aspect, and the possible implementations of the first aspect and the third aspect.

According to a sixteenth aspect, an embodiment of this application provides a readable storage medium. The readable storage medium is configured to store instructions, to implement any one of the second aspect and the possible implementations of the second aspect.

According to a seventeenth aspect, an embodiment of this application provides a readable storage medium. The readable storage medium is configured to store instructions, to implement any one of the fourth aspect and the possible implementations of the fourth aspect.

### BRIEF DESCRIPTION OF DRAWINGS

To describe technical solutions in embodiments of this application more clearly, the following describes the accompanying drawings used in the embodiments of this application.

FIG. 1 is a possible schematic architectural diagram of a communication system according to an embodiment of this application;

FIG. 2 is a schematic flowchart of a communication method according to an embodiment of this application;

FIG. 3 is a schematic flowchart of another communication method according to an embodiment of this application;

FIG. 4 is a schematic flowchart of another communication method according to an embodiment of this application;

FIG. 5 is a schematic flowchart of another communication method according to an embodiment of this application;

FIG. 6 is a schematic flowchart of another communication method according to an embodiment of this application;

FIG. 7 is a schematic structural diagram of a terminal device according to an embodiment of this application;

FIG. 8 is a schematic structural diagram of another terminal device according to an embodiment of this application;

FIG. 9 is a schematic structural diagram of a core network device according to an embodiment of this application;

FIG. 10 is a schematic structural diagram of another core network device according to an embodiment of this application;

FIG. 11 is a schematic structural diagram of a radio access network device according to an embodiment of this application; and

FIG. 12 is a schematic structural diagram of another radio access network device according to an embodiment of this application.

### DESCRIPTION OF EMBODIMENTS

The following describes embodiments of this application with reference to the accompanying drawings in the embodiments of this application.

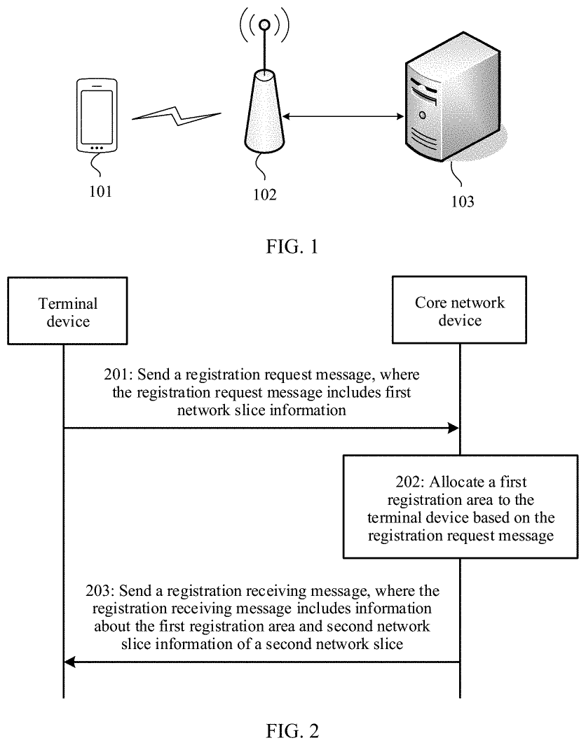

FIG. 1 is a possible schematic architectural diagram of a communication system according to an embodiment of this application. The communication system includes a terminal device 101, a radio access network device 102, and a core network device 103. The terminal device 101 and the radio access network device 102 communicate with each other by using an air interface technology, and there is a communication interface between the core network device 103 and the radio access network device 102. For example, the communication interface is an NG interface.

A network slice in this application is a logical network that provides specific network capabilities and network characteristics (a logic network that provides specific network capabilities and network characteristics). The network slices are logical networks having different network capabilities and network characteristics that are customized on a physical or virtual network infrastructure based on different service requirements, tenants, or the like. The network slice includes a group of network capabilities and resources (for example, a computing resource, a storage resource, and a network resource) required for the network capabilities.

There are a plurality of types of services in the terminal device 101, for example, an enhanced mobile broadband service (eMBB), ultra-reliable low-latency communication (URLLC), and massive machine-type communications (mMTC). Different types of service sessions may correspond to different network slices. Because provided operators or service providers are different, even a same service type may also correspond to different network slices.

In this way, in a case in which the terminal device 101 needs to establish a plurality of protocol data unit (PDU) sessions, the terminal device 101 needs to register with the network slice. A specific process is as follows:

(1) The terminal device 101 provides requested network slice selection assistance information (requested NSSAI) to the core network device 103. The requested NSSAI is used to indicate NSSAI provided by the terminal device 101 to a serving public land mobile network in a registration process. For example, the requested NSSAI is NSSAI that is determined when the terminal device 101 performs subscription and that is supported by the terminal device 101. The requested NSSAI includes one piece or a plurality of pieces of single network slice selection assistance information (S-NSSAI), and one piece of S-NSSAI may be used to identify one network slice.

(2) The core network device 103 determines allowed network slice selection assistance information (allowed NSSAI) of the terminal device 101, and sends the allowed NSSAI to the terminal device 101. The allowed NSSAI is used to indicate S-NSSAI that can be used by the terminal device 101 in all tracking areas in a current registration area. The allowed NSSAI includes at least one piece of S-NSSAI included in the requested NSSAI.

The tracking area (TA) is a basic unit of location management in a communication system, and includes one or more cells. The cell is an area covered by a radio access network device or a part of an area covered by a radio access network device, and the TA may include cells included in a plurality of radio access network devices. When the terminal device 101 in an idle state needs to be paged, a paging message is used for paging by using the TA as a unit, and a paging message for one terminal device 101 is sent in all the cells in the TA. One cell can belong to only one TA.

A registration area (RA) includes one or more TAs. For example, when moving in different TAs in a same RA, the terminal device 101 does not need to perform mobility registration update. The mobility registration update needs to be performed only when the terminal device 101 moves to a new TA and the new TA is determined not to belong to the RA.

In a process in which the core network device 103 determines the allowed NSSAI of the terminal device 101, the core network device 103 may query, from a network management system, an available network slice in each TA included in a current RA allocated to the terminal device, and determine, with reference to requested NSSAI that is included in a registration request message by the terminal device 101, the allowed NSSAI of the terminal device 101 in the current RA. The network management system is an operation, administration and maintenance (OAM) system.

In a case in which the requested NSSAI includes a plurality of pieces of S-NSSAI, and the allowed NSSAI sent by the core network device 103 includes one part of the S-NSSAI in the requested NSSAI, the other part of the S-NSSAI included in the requested NSSAI of the terminal device 101 is not in the allowed NSSAI. In this way, even if the terminal device 101 is in a coverage area that supports using the other part of the S-NSSAI, the terminal device 101 is not allowed to use the another part of the S-NSSAI.

For example, refer to Table 1. A network slice included in the requested NSSAI is provided. The current registration area includes three TAs: a TA 1, a TA 2 and a TA 3, and an available network slice in each TA. Finally, the allowed NSSAI sent by the core network device 103 includes only S-NSSAI 3. In this case, even when the terminal device 101 is within an area range in which S-NSSAI 1 can be used (for example, when the terminal device 101 is located in the TA 1), a network does not allow the terminal device 101 to use the S-NSSAI 1, so that the terminal device 101 cannot establish a PDU session of the S-NSSAI 1. This manner limits a quantity or types of network slices that can be used by the terminal device 101 in a coverage area of a current radio access network device, and also limits a type of a PDU session that can be established by the terminal device 101. Consequently, a requirement that the terminal device 101 performs communication by using the network slice cannot be met.

TABLE 1

| Requested NSSAI | | S-NSSAI 1, S-NSSAI 2, S-NSSAI 3, S-NSSAI 4, and S-NSSAI 5 |
|---|---|---|
| RA | TA 1 | S-NSSAI 1, S-NSSAI 2, and S-NSSAI 3 |
| | TA 2 | S-NSSAI 2, S-NSSAI 3, and S-NSSAI 4 |
| | TA 3 | S-NSSAI 3, S-NSSAI 4, and S-NSSAI 5 |

| | |
|---|---|
| Allowed NSSAI | S-NSSAI 3 |

In this application, a terminal device may send, to a core network device, information about a network slice corresponding to a PDU session that is expected to be established. The core network device may reallocate an RA to the terminal device based on the information about the network slice corresponding to the PDU session that the terminal device expects to establish. In addition, the reallocated RA can support network slices corresponding to all sessions that the terminal device expects to establish. In this way, a quantity or types of network slices that can be used by the terminal device in a coverage area of a current radio access network device is/are expanded, and a type of a PDU session that can be established by the terminal device is also increased, thereby meeting, to a greater extent, a requirement that the terminal device performs communication by using the network slice.

The following describes network elements in FIG. 1 and this embodiment of this application.

The terminal device 101 may be user equipment (UE), and the UE accesses a network side through the radio access network device 102. For example, the UE may be a handheld terminal device 101, a notebook computer, a subscriber unit, a cellular phone, a smartphone, a wireless data card, a personal digital assistant (PDA) computer, a tablet computer, a wireless modem, a handheld device, a laptop computer, a cordless phone or a wireless local loop (WLL) station, a machine type communication (MTC) terminal, or another device that can access a network.

The radio access network (RAN) device 102 is mainly responsible for functions such as radio resource management, quality of service (QoS) management, and data compression and encryption on an air interface side. The radio access network device 102 may include base stations in various forms, such as a macro base station, a micro base station (which is also referred to as a small cell), a relay station, and an access point. In systems that use different radio access technologies, names of a device that has a base station function may be different. For example, in a 5G system, the device is referred to as a gNB, or a next-generation evolved NodeB (ng-eNB). In a long term evolution (LTE) system, the device is referred to as an evolved NodeB (eNB, or eNodeB). In a 3rd generation (3G) system, the device is referred to as a NodeB (node B).

The core network device 103 may be an access and mobility management function (AMF), and is mainly responsible for functions such as access control, mobility management (MM), attachment and detachment, and gateway selection. The core network device 103 in this embodiment of this application is not limited to the AMF.

It should be noted that, in an optional manner, information about the network slice supported by the radio access network device in any one of the embodiments of this application may include an identifier of at least one first TA and at least one piece of network slice information corresponding to an identifier of each first TA. For example, a specific representation form is as follows: (A name is merely an example, and is not limited in this embodiment of this application) The identifier of the first TA may be represented by using a tracking area identity (TAI) or a tracking area code (TAC), and an S-NSSAI list represents at least one piece of network slice information. One TAI or TAC may correspond to at least one S-NSSAI list.
TAI or TAC
S-NSSAI list

One radio access network device may include one or more cells, each cell is allocated to one TA, and one cell can be allocated to only one TA. The at least one first TA herein is used to indicate TAs to which all the cells included in the radio access network device are allocated. Each first TA may support one or more network slices. In this way, one identifier of the first TA may correspond to at least one piece of network slice information.

It should be further noted that, one piece of network slice information in any one of the embodiments of this application includes one or more pieces of S-NSSAI. The S-NSSAI includes at least slice/service type (SST) information, and optionally, may further include slice differentiator (SD) information. The SST information is used to indicate behavior of a network slice, such as a feature and a service type of the network slice. The SD information is supplement information of an SST. If the SST points to a plurality of network slice instances, an SD may correspond to one unique network slice instance.

It should be understood that, in this embodiment of this application, the network slice information may be represented by using a network slice type. Alternatively, the network slice information may be represented by using a network slice type and a service type. Alternatively, the network slice information may be represented by using a service type and tenant information, or the like. This is not limited in this embodiment of this application. Optionally, a specific coding form of the network slice information is not limited. Different fields that can be carried in an interface message between different devices represents different network slice information. Alternatively, an abstracted index value can be used for replacement, and different index values correspond to different network slices. Certainly, in addition to the foregoing identifiers, another identifier may also be used. This is not limited herein.

This embodiment of this application may be applied to another communication system that supports a network slice, for example, a 5G communication system. The terms “system” and “network” can be interchanged with each other. The system architecture described in this embodiment of this application is intended to describe the technical solutions in the embodiments of this application more clearly, and does not constitute a limitation on the technical solutions provided in the embodiments of this application. A person of ordinary skill in the art may know that, as a network architecture evolves, the technical solutions provided in the embodiments of this application are also applicable to a similar technical problem.

The following describes an embodiment of this application.

Based on the communication system shown in FIG. 1, FIG. 2 is a schematic flowchart of a communication method according to this application. The method shown in FIG. 2 includes operation 201 to operation 203.

201: A terminal device sends a registration request message to a core network device through a radio access network device. The registration request message includes first network slice information.

Correspondingly, the core network device receives the registration request message through the radio access network device. The registration request message herein may alternatively have another name. This is not limited in this embodiment of this application.

The registration request message includes fourth network slice information, and the fourth network slice information is requested NSSAI. The requested NSSAI is used to indicate a fourth network slice provided by the terminal device to a serving public land mobile network in a registration process. For example, the requested NSSAI is NSSAI that is determined when the terminal device performs subscription and that is supported by the terminal device. The requested NSSAI includes at least one piece of S-NSSAI.

The first network slice information further included in the registration request message is information about a first network slice corresponding to a PDU session that the terminal device expects to establish. For example, that the first network slice information is preferred NSSAI specifically means that NSSAI provided to the serving public land mobile network is used to indicate S-NSSAI used by the PDU session that the terminal device expects to establish (NSSAI provided by the UE to the Serving PLMN, indicating the S-NSSAI values in which the UE wants to establish a PDU session). The first network slice information includes at least one piece of S-NSSAI.

The first network slice is a subset or a complete set of the fourth network slice. For example, the fourth network slice includes a network slice 1, a network slice 2, and a network slice 3, and the first network slice may be the network slice 2. The registration request message in operation 201 needs to carry the fourth network slice information and the first network slice information.

Optionally, the registration request message further includes slice availability information. The slice availability information includes information about whether the first network slice is available in a TA included in a historically allocated second RA. The second RA herein may be one or more historically allocated second RAs, and the included TA is also a TA included in the one or more second RAs. After the slice availability information is sent to the core network device, the core network device may allocate a first RA to the terminal device based on the slice availability information, so that the terminal device may use the first network slice in the first RA.

For example, the fourth network slice includes the network slice 1, the network slice 2, the network slice 3, a network slice 4, and a network slice 5. The first network slice includes the network slice 2, the network slice 3, and the network slice 4. For the first network slice information and the slice availability information that are included in the registration request message, refer to Table 2.

TABLE 2

| First network | | | | | | |
|---|---|---|---|---|---|---|
| slice | TA 11 | TA 12 | TA 13 | TA 14 | TA 15 | TA 16 |
| Network slice | Unavailable | Available | Unavailable | Available | Available | Unavailable |
| 2 | | | | | | |
| Network slice | Unavailable | Available | Unavailable | Available | Available | Available |
| 3 | | | | | | |
| Network slice | Available | Available | Available | Available | Available | Available |
| 4 | | | | | | |

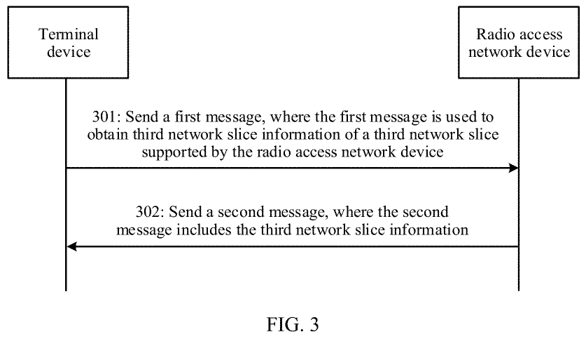

Further, in the foregoing possible implementation, the first network slice is not only a network slice corresponding to the PDU session that the terminal device expects to establish, but also a network slice supported by the radio access network device. For example, the network slice corresponding to the PDU session that the terminal device expects to establish includes the network slice 2, the network slice 3, and the network slice 4. The terminal device determines that a network slice supported by a currently accessed radio access network device includes the network slice 3 and the network slice 4. Therefore, the first network slice included in the registration request message by the terminal device is the network slice 3 and the network slice 4. In this way, expected first network slice information is more easily included in second network slice information allowed by the core network device, and the terminal device does not need to include, in the registration request message, information about a network slice that is not supported by the radio access network device, thereby reducing transmission overheads caused because the terminal device includes, in the registration request message, the information that is not supported by the radio access network device. For details that the terminal device obtains third network slice information of a third network slice supported by the radio access network device, refer to specific descriptions in the embodiments shown in FIG. 3 to FIG. 6.

It should be noted that the registration request message in this embodiment of this application is sent by the terminal device in a mobility registration update scenario. For example, when the terminal device in a connected state or an idle state is handed over to a new TA that does not belong to a current RA, or when the terminal device needs to update a capability or a protocol parameter negotiated in a registration process, or when the terminal device expects to obtain information about a local area data network, the terminal device initiates a mobility registration update procedure. Alternatively, the registration request message is sent by the terminal device in a periodic registration update scenario. For example, the terminal device sends a periodic registration request message at a preset time interval. Alternatively, the registration request message is sent by the terminal device in an emergency registration update scenario.

202: The core network device allocates the first registration area to the terminal device based on the registration request message.

The first RA allocated by the core network device supports at least a second network slice, and the second network slice is a network slice that is allowed to be accessed by the terminal device in the first RA.

In a first possible implementation, the registration request message includes the first network slice information. A specific manner in which the core network device performs operation 202 is as follows: The core network device queries a fifth network slice supported by each of a plurality of TAs. The core network device determines, from the plurality of TAs, a TA that supports the first network slice, and forms the first RA by using the TA that supports the first network slice.

For example, the plurality of TAs queried by the core network device include eight TAs. For fifth network slices respectively supported by the eight TAs, refer to Table 3. The first network slice includes the network slice 2, the network slice 3, and the network slice 4. It can be learned that TAs that support the first network slice include: a TA 22, a TA 23, a TA 26, and a TA 28. The core network device forms the first RA by using the TA 22, the TA 23, the TA 26, and the TA 28 that support the first network slice.

TABLE 3

| A plurality of TAs | Supported fifth network slice |
|---|---|
| TA 21 | Network slice 1, network slice 3, network slice 4, network slice 5, and |
| | network slice 6 |
| TA 22 | Network slice 1, network slice 2, network slice 3, and network slice 4 |
| TA 23 | Network slice 1, network slice 2, network slice 3, network slice 4, and |
| | network slice 5 |
| TA 24 | Network slice 3, network slice 4, network slice 5, and network slice 6 |
| TA 25 | Network slice 2, network slice 3, network slice 5, and network slice 6 |
| TA 26 | Network slice 2, network slice 3, network slice 4, and network slice 6 |
| TA 27 | Network slice 1, network slice 3, network slice 5, and network slice 6 |
| TA 28 | Network slice 2, network slice 3, network slice 4, and network slice 5 |

In a second possible implementation, the registration request message includes the first network slice information and the slice availability information. In one case, the core network device may determine, based only on the first network slice information carried in the registration request message and according to the first possible implementation solution, the first RA allocated to the terminal device. In another case, a specific implementation in which the core network device performs operation 202 is as follows: The core network device determines a plurality of TAs from the registration request message, and the plurality of TAs are TAs included in a second RA historically allocated to the terminal device. The core network device determines, from the plurality of TAs, a TA that supports the first network slice, and forms the first RA by using the TA that supports the first network slice.

For example, Table 2 is used as an example. For the first network slice information and the slice availability information that are included in the registration request message received by the core network device, refer to Table 2. The plurality of TAs determined by the core network device include a TA 11, a TA 12, a TA 13, a TA 14, a TA 15, and a TA 16. The first network slice includes the network slice 2, the network slice 3, and the network slice 4. It can be learned that TAs that support the first network slice include: the TA 12, the TA 14, and the TA 15. The core network device forms the first RA by using the TA 12, the TA 14, and the TA 15 that support the first network slice.

A quantity of the plurality of TAs in the foregoing examples is merely an example for description. The quantity of the TAs queried by the core network device is not limited in this application. Optionally, the core network device may query, from OAM, a TA and a network slice that can be used in the TA.

203: The core network device sends a registration receiving message to the terminal device through the radio access network device, where the registration receiving message includes information about the first RA and second network slice information of the second network slice.

Correspondingly, the terminal device receives, through the radio access network device, the registration receiving message sent by the core network device. The registration receiving message herein may alternatively have another name. This is not limited in this embodiment of this application.

The registration receiving message includes the information about the first RA allocated to the terminal device and the second network slice information, and the second network slice information is information about the second network slice that is allowed to be accessed by the terminal device in the first RA.

Optionally, the first RA includes at least one TA, and the information about the first RA may be an identifier of an RA and an identifier of each of a plurality of TAs included in the first RA.

Optionally, the second network slice information includes at least the first network slice information. In this way, the core network device can allow all the first network slices, expected by the terminal device, to be used, thereby meeting a requirement of the terminal device to a greater extent. In addition, the second network slice information may further include information about another network slice in the fourth network slice supported by the first RA, so that the terminal device may directly use the another network slice in a case in which the terminal device needs to use the another network slice, thereby saving time of the terminal device requesting to use the another network slice.

It should be noted that, in this embodiment of this application, the terminal device communicates with the core network device through the radio access network device. For example, a specific implementation of operation 201 is as follows: The terminal device sends the registration request message to the radio access network device, and the radio access network device sends the registration request message to the core network device. Optionally, the registration request message sent by the terminal device to the radio access network device may be different from the registration request message sent by the radio access network device to the core network device in terms of message names, but the sent message includes at least the first network slice information.

Similarly, the core network device also communicates with the terminal device through the radio access network device. For example, a specific implementation of operation 203 is as follows: The core network device sends the registration receiving message to the radio access network device, and the radio access network device sends the registration receiving message to the terminal device. Optionally, the registration receiving message sent by the core network device to the radio access network device may be different from the registration receiving message sent by the radio access network device to the terminal device in terms of message names, but the sent message includes at least the information about the first RA and the second network slice information.

It should be further noted that the radio access network device through which the terminal device obtains the third network slice information is the same as the radio access network device through which the terminal device communicates with the core network device.

In this embodiment of this application, the terminal device may send, to the core network device, information about the network slice corresponding to the PDU session that is expected to be established. The core network device may reallocate an RA to the terminal device based on the information about the network slice corresponding to the PDU session that the terminal device expects to establish. In addition, the reallocated RA can support network slices corresponding to all sessions that the terminal device expects to establish. In this way, a quantity or types of network slices that can be used by the terminal device in a coverage area of a current radio access network device is/are expanded, and a type of a PDU session that can be established by the terminal device is also increased, thereby meeting, to a greater extent, a requirement that the terminal device performs communication by using the network slice.

In any one of the following embodiments shown in FIG. 3 to FIG. 6, the terminal device may obtain the third network slice information of the third network slice supported by the radio access network device. FIG. 3 is a possible schematic flowchart of a communication method according to an embodiment of this application. As shown in FIG. 3, the method includes operation 301 and operation 302.

301: A terminal device sends a first message to the radio access network device.

Correspondingly, the radio access network device receives the first message.

The first message is used to obtain third network slice information of a third network slice supported by the radio access network device.

Optionally, the first message may carry indication information, the indication information is used to obtain the third network slice information of the third network slice supported by the radio access network device, and the indication information is used to indicate information obtained through the first message. For example, the first message carries an information element (IE). When a bit value of the information element is “1”, it indicates that the information element is used to obtain the third network slice information, so that the radio access network device feeds back the third network slice information. A quantity of bits occupied by the first indication information is not limited in this embodiment of this application.

Alternatively, optionally, the first message may carry a requested system information block identifier, the requested system information block identifier is used to obtain the third network slice information, and the requested system information block identifier is used to indicate information obtained through the first message. For example, if an SIB 10 includes the third network slice information supported by the radio access network device, the terminal device includes the requested SIB 10 in the first message, and sends the first message to the radio access network device, so that the radio access network device feeds back the third network slice information.

302: The radio access network device sends a second message to the terminal device.

Correspondingly, the terminal device receives the second message.

The second message includes the third network slice information.

Optionally, the first message is a radio resource control RRC system information request message, the second message is a system information message, and the system information message includes the third network slice information.

Optionally, the first message is a random access preamble message, and the second message is a system information message.

Optionally, the first message is a radio resource control RRC request message, and the second message is an RRC response message.

In this embodiment of this application, the first message or the second message may be a message existing in a current standard, and the existing message is used to implement the solution in the embodiment in FIG. 3. Alternatively, the first message or the second message may be a new message. This is not limited in this embodiment of this application.

Optionally, the terminal device may perform a registration procedure after operation 302. Specifically, the terminal device needs to perform the registration procedure. For example, in a mobility registration update scenario, the terminal device performs the registration procedure; in a periodic registration update scenario, the terminal device performs the registration procedure; in an emergency registration update scenario, the terminal device performs the registration procedure. For a specific implementation process of performing the registration procedure, refer to the specific descriptions of the embodiment shown in FIG. 2. In this way, the first network slice in operation 201 may be not only a network slice corresponding to a PDU session that the terminal device expects to establish, but also a network slice supported by the radio access network device.

In this embodiment of this application, the terminal device may obtain the third network slice information of the third network slice supported by the radio access network device, so that the terminal device determines, in a coverage area of a current radio access network device, a quantity or types of network slices supported by the radio access network device.

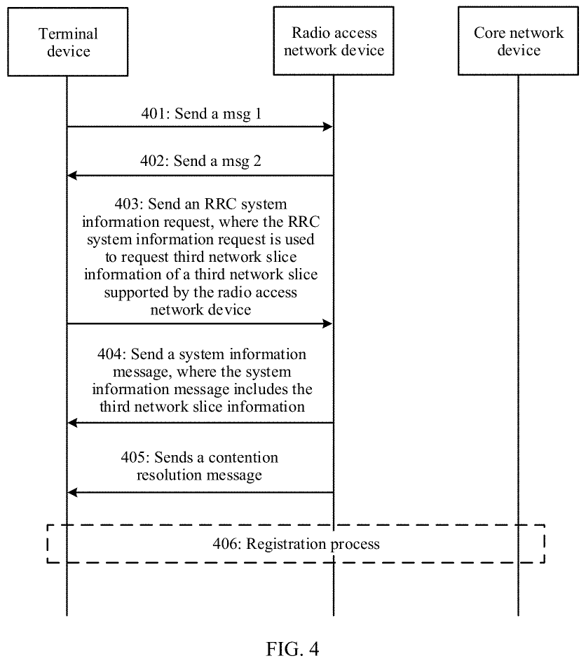

The solution in which the terminal device obtains the third network slice information in the embodiment shown in FIG. 3 may be applied to a random access procedure. For details, refer to descriptions in the embodiments shown in FIG. 4 to FIG. 6. The random access procedure in this application includes the following four operations.

1. The terminal device sends a random access preamble message to the radio access network device. The message includes a random access preamble sequence. A main purpose of sending the random access preamble sequence is to notify the radio access network device that the terminal device attempts to perform access, and enable the radio access network device to estimate a latency from the terminal device to the radio access network device. This latency estimation value is used to send, in operation 2, a timing advance that is used to adjust an uplink sending time of the terminal device. A time-frequency resource occupied for sending the random access preamble sequence is referred to as a physical random access channel (PRACH) resource. The radio access network device broadcasts an allowed available random access preamble sequence and a related PRACH resource through system information. The terminal device selects one random access preamble sequence and sends the random access preamble sequence on a PRACH. The random access preamble message is generally referred to as a message 1 (msg 1).

2. The radio access network device sends a random access response message to the terminal device. The message includes: (1) an index value of the random access preamble sequence detected by the radio access network device, used to indicate that this response is valid for random access of a specific terminal device; (2) a timing advance calculated through the received random access preamble sequence; (3) a scheduling indication, used to indicate a time-frequency resource used by the terminal device when the terminal device sends a message in operation 3 of the random access; and (4) a temporary cell radio network temporary identifier (TC-RNTI), used for further communication between the terminal device and a network side. The random access response message is generally referred to as a message 2 (msg 2).

3. The terminal device sends a scheduling transmission message to the radio access network device, and the scheduling transmission message is used to send an exact random access procedure message (which is also referred to as a payload), such as an RRC connection request, a TA update, or the like. The scheduling transmission message also includes the TC-RNTI allocated in operation 2, and an initial terminal device identifier or a cell radio network temporary identifier (C-RNTI). If there is a random access preamble sequence conflict in operation 1, terminal devices that have the conflict receive a same TC-RNTI in operation 2. When the terminal device sends the payload, there is also a conflict on a same uplink time-frequency resource, and this causes interference. Consequently, the terminal devices that have the conflict cannot correctly perform decoding. The scheduling transmission message is generally referred to as a message 3 (msg 3).

4. The radio access network device sends a contention resolution message to the terminal device, where the message includes the initial terminal device identifier in operation 3. After receiving the contention resolution message, the terminal device has three possible behaviors: (1) If the terminal device correctly decodes the contention resolution message and detects an initial terminal device identifier of the terminal device, the terminal device feeds back a positive acknowledgment to the radio access network device. (2) If the terminal device correctly decodes the contention resolution message and detects that the message includes another initial terminal device identifier, it indicates that the conflict is not resolved. In this case, the terminal device does not feed back a positive acknowledgment. (3) If the terminal device fails to decode the contention resolution message or misses a downlink grant signal, the terminal device does not feed back a positive acknowledgment. The contention resolution message is generally referred to as a message 4 (msg 4).

FIG. 4 is a possible schematic flowchart of a communication method according to an embodiment of this application. As shown in FIG. 4, the method includes operation 401 to operation 406.

401: A terminal device sends a msg 1 to a radio access network device.

402: The radio access network device sends a msg 2 to the terminal device.

403: The terminal device sends an RRC system information request to the radio access network device.

The RRC system information request is used to obtain third network slice information of a third network slice supported by the radio access network device. The RRC system information request may be carried in a msg 3 for sending.

404: The radio access network device sends a system information message to the terminal device.

The system information message includes the third network slice information.

For operation 403 and operation 404, in a possible implementation, the RRC system information request includes a requested system information block identifier. The system information block identifier may be used to indicate to obtain the third network slice information. The requested system information block identifier herein is configured or agreed on by the terminal device and the radio access network device in advance.

For example, if an SIB 10 includes network slice information supported by the radio access network device, the RRC system information request sent by the terminal device includes an identifier of the SIB 10. After receiving the RRC system information request including the SIB 10, the radio access network device sends system information SIB 10 to the terminal device, and the SIB 10 includes the third network slice information supported by the radio access network device.

For another example, the requested system information block identifier may be represented in a form of a requested-system information-list (requested-SI-List). The requested-SI-List includes at least one system information block identifier, and includes a system information block identifier used to obtain the third network slice information of the third network slice supported by the radio access network device. Therefore, the radio access network device feeds back the system information block. For example, if an SIB 10 includes network slice information supported by the radio access network device, the terminal device sets a requested-SI-List, where the requested-SI-List indicates that the terminal device needs to obtain the SIB 10. The terminal device sends the RRC system information request including the requested-SI-List to the radio access network device. Correspondingly, after receiving the RRC system information request, the radio access network device sends the system information message including the SIB 10 to the terminal device. In this way, the terminal device may obtain the third network slice information of the third network slice supported by the radio access network device.

Optionally, in addition to an SIB used to obtain the third network slice information, the requested-SI-List may further include an SIB identifier used to obtain other information. For example, the requested-SI-List may further include an SIB 2, an SIB 3, and the like.

For operation 403 and operation 404, in another possible implementation, an RRC system information request message includes first indication information, and the first indication information is used to obtain the third network slice information of the third network slice supported by the radio access network device. Therefore, the radio access network device feeds back the third network slice information based on the first indication information. For example, when the first indication information is “01”, it indicates that the first indication information is used to obtain the third network slice information, and the terminal device sends the RRC system information request message including the first indication information to the radio access network device. Correspondingly, after receiving the RRC system information request message, the radio access network device sends the system information message including the third network slice information to the terminal device when determining that the first indication information is “01”. In this way, the terminal device may obtain the third network slice information of the third network slice supported by the radio access network device.

405: The radio access network device sends a contention resolution message to the terminal device.

Optionally, a sequence of performing operation 404 and operation 405 is not limited in this application.

406: The terminal device performs a registration procedure.

Step 406 is an optional operation. The terminal device needs to perform the registration procedure. For example, in a mobility registration update scenario, the terminal device performs the registration procedure; in a periodic registration update scenario, the terminal device performs the registration procedure; in an emergency registration update scenario, the terminal device performs the registration procedure. Optionally, for a specific implementation process of operation 406, refer to the specific descriptions of the embodiment shown in FIG. 2. In this way, the first network slice in operation 201 may be not only a network slice corresponding to a PDU session that the terminal device expects to establish, but also a network slice supported by the radio access network device.

In this embodiment of this application, after performing a random access procedure to establish a connection to the radio access network device, the terminal device may obtain the third network slice information of the third network slice supported by the radio access network device. In addition, the terminal device may initiate a registration procedure based on the obtained third network slice information.

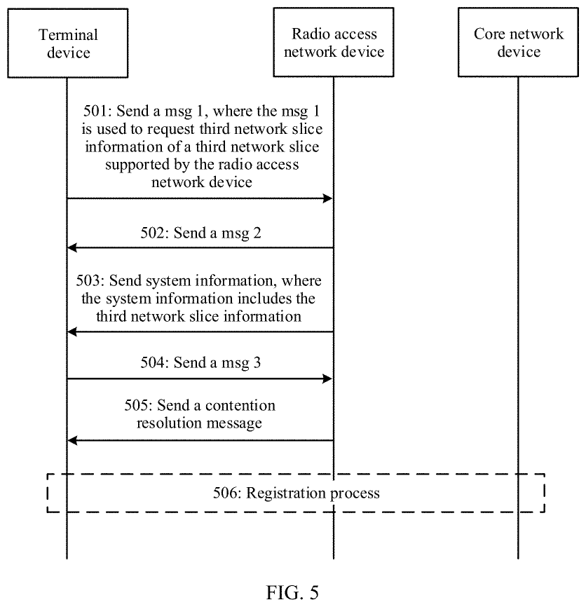

FIG. 5 is a possible schematic flowchart of another communication method according to an embodiment of this application. As shown in FIG. 5, the method includes operation 501 to operation 506. According to the method, a terminal device may obtain third network slice information of a third network slice supported by a radio access network device.

501: The terminal device sends a msg 1 to the radio access network device.

The msg 1 is used to obtain the third network slice information of the third network slice supported by the radio access network device.

502: The radio access network device sends a msg 2 to the terminal device.

503: The radio access network device sends a system information message to the terminal device.

The system information message includes the third network slice information.

Optionally, a sequence of performing operation 502 and operation 503 is not limited in this application.

For operation 501 and operation 503, in a possible implementation, the msg 1 includes a requested system information block identifier. The system information block identifier may be used to indicate to obtain the third network slice information. The requested system information block identifier herein is configured or agreed on by the terminal device and the radio access network device in advance.

For example, if an SIB 10 includes network slice information supported by the radio access network device, an RRC system information request sent by the terminal device includes an identifier of the SIB 10. After receiving the RRC system information request including the SIB 10, the radio access network device sends system information SIB 10 to the terminal device, and the SIB 10 includes the third network slice information supported by the radio access network device.

For another example, the requested system information block identifier may be represented in a form of a requested-SI-List. The requested-SI-List includes at least one SIB identifier, and includes an SIB identifier used to obtain the third network slice information of the third network slice supported by the radio access network device. Therefore, the radio access network device feeds back the system information block. For example, if an SIB 10 includes network slice information supported by the radio access network device, the terminal device sets a requested-SI-List, where the requested-SI-List indicates that the terminal device needs to obtain the SIB 10. The terminal device sends the msg 1 including the requested-SI-List to the radio access network device. Correspondingly, after receiving the msg 1, the radio access network device sends the system information message including the SIB 10 to the terminal device. In this way, the terminal device may obtain the third network slice information of the third network slice supported by the radio access network device.

Optionally, in addition to an SIB used to obtain the third network slice information, the requested-SI-List may further include an SIB identifier used to obtain other information. For example, the requested-SI-List may further include an SIB 2, an SIB 3, and the like.

For operation 501 and operation 503, in another possible implementation, the msg 1 includes second indication information, and the second indication information is used to obtain the third network slice information of the third network slice supported by the radio access network device. Therefore, the radio access network device feeds back the third network slice information based on the second indication information. For example, when the second indication information is “10”, it indicates that the second indication information is used to obtain the third network slice information, and the terminal device sends the msg 1 including the second indication information to the radio access network device. Correspondingly, after receiving the msg 1, the radio access network device sends the system information message including the third network slice information to the terminal device when determining that the second indication information is “10”. In this way, the terminal device may obtain the third network slice information of the third network slice supported by the radio access network device.

504: The radio access network device sends a msg 3 to the terminal device.

505: The radio access network device sends a contention resolution message to the terminal device.

Optionally, a sequence of performing operation 504 and operation 505 is not limited in this application.

506: The terminal device performs a registration procedure.

Step 506 is an optional operation. The terminal device needs to perform the registration procedure in several cases. For example, in a mobility registration update scenario, the terminal device performs the registration procedure; in a periodic registration update scenario, the terminal device performs the registration procedure; in an emergency registration update scenario, the terminal device performs the registration procedure. Optionally, for a specific implementation process of operation 506, refer to the specific descriptions of the embodiment shown in FIG. 2. In this way, the first network slice in operation 201 may be not only a network slice corresponding to a PDU session that the terminal device expects to establish, but also a network slice supported by the radio access network device.

In this embodiment of this application, after performing a random access procedure to establish a connection to the radio access network device, the terminal device may obtain the third network slice information of the third network slice supported by the radio access network device. In addition, the terminal device may initiate a registration procedure based on the obtained third network slice information.

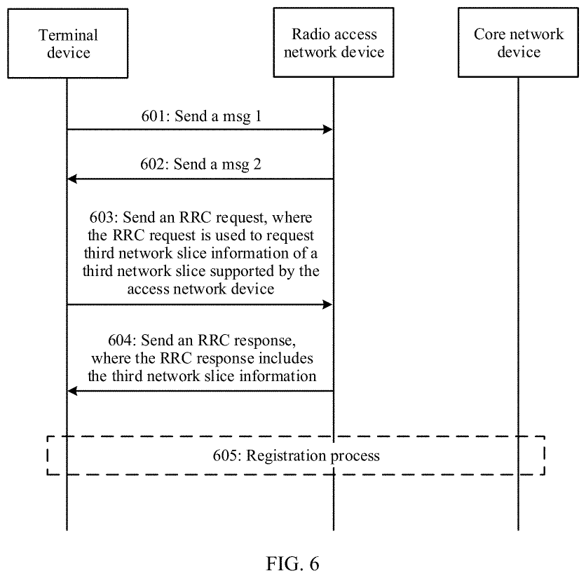

FIG. 6 is a possible schematic flowchart of another communication method according to an embodiment of this application. As shown in FIG. 6, the method includes operation 601 to operation 605. According to the method, a terminal device may obtain third network slice information of a third network slice supported by a radio access network device.

601: The terminal device sends a msg 1 to the radio access network device.

602: The radio access network device sends a msg 2 to the terminal device.

603: The terminal device sends an RRC request message to the radio access network device.

The RRC request message is used to obtain the third network slice information of the third network slice supported by the radio access network device. The RRC request message may be a msg 3 sent by the terminal device, so that the msg 3 may be used to obtain the third network slice information of the third network slice supported by the radio access network device.

604: The radio access network device sends an RRC response message to the terminal device.

The RRC response message includes the third network slice information. The RRC response message may be a contention resolution message sent by the radio access network device. In this way, the terminal device may obtain the third network slice information through the contention resolution message.

For operation 603 and operation 604, in a possible implementation, the RRC request message includes third indication information, and the third indication information is used to obtain the third network slice information of the third network slice supported by the radio access network device. Therefore, the radio access network device feeds back the third network slice information based on the third indication information. For example, when the third indication information is “11”, it indicates that the third indication information is used to obtain the third network slice information, and the terminal device sends the RRC request message including the third indication information to the radio access network device. Correspondingly, after receiving the RRC request message, the radio access network device sends the RRC response message to the terminal device when determining that the third indication information is “11”, and the RRC response message includes the third network slice information. In this way, the terminal device may obtain the third network slice information of the third network slice supported by the radio access network device.

Optionally, the RRC request message may be: an RRC setup request message, an RRC reestablishment request message, an RRC resume request message, or another dedicated RRC request message. Corresponding to the RRC request message, the RRC response message may be: an RRC setup message, an RRC reestablishment message, an RRC resume message, or another dedicated RRC response message.

605: The terminal device performs a registration procedure.

Step 605 is an optional operation. The terminal device needs to perform the registration procedure. For example, in a mobility registration update scenario, the terminal device performs the registration procedure; in a periodic registration update scenario, the terminal device performs the registration procedure; in an emergency registration update scenario, the terminal device performs the registration procedure. Optionally, for a specific implementation process of operation 605, refer to the specific descriptions of the embodiment shown in FIG. 2. In this way, the first network slice in operation 201 may be not only a network slice corresponding to a PDU session that the terminal device expects to establish, but also a network slice supported by the radio access network device.

In this embodiment of this application, after performing a random access procedure to establish a connection to the radio access network device, the terminal device may obtain the third network slice information of the third network slice supported by the radio access network device. In addition, the terminal device may initiate a registration procedure based on the obtained third network slice information.

The foregoing mainly describes, from the perspective of the devices, the solutions provided in the embodiments of this application. It may be understood that, to implement the foregoing functions, the terminal device and the network device include corresponding hardware structures and/or software modules for performing the functions. With reference to the operations of each example described in the embodiments disclosed in this application, the embodiments of this application can be implemented in a form of hardware or a combination of hardware and computer software. Whether a function is performed by hardware or hardware driven by computer software depends on particular applications and design constraints of the technical solutions. A person skilled in the art may use different devices to implement the described functions for each particular application, but it should not be considered that the implementation goes beyond the scope of the technical solutions in the embodiments of this application.

In the embodiments of this application, the terminal device and the network device may be divided into functional modules or functional units based on the foregoing device examples. For example, each functional module or functional unit may be obtained through division based on each corresponding function, or two or more functions may be integrated into one processing module or processing unit. The integrated module or unit may be implemented in a form of hardware, or may be implemented in a form of a software functional module. It should be noted that, in the embodiments of this application, division into the modules or the units is an example, and is merely logical function division. During actual implementation, there may be another division manner.

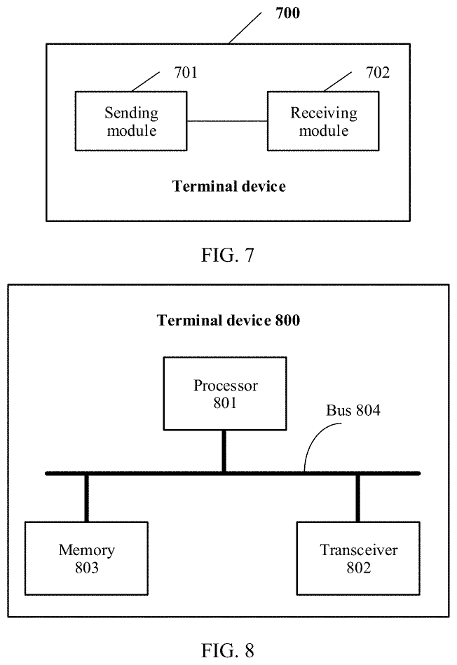

FIG. 7 is a schematic structural diagram of a terminal device according to an embodiment of this application. The terminal device 700 is configured to implement the method embodiments in FIG. 2 to FIG. 6. As shown in FIG. 7, the terminal device 700 includes a sending module 701 and a receiving module 702.

In a possible implementation, the sending module 701 is configured to send a registration request message to a core network device through a radio access network device, where the registration request message includes first network slice information, and the first network slice information is information about a first network slice corresponding to a PDU session that the terminal device expects to establish.

The receiving module 702 is configured to receive, through the radio access network device, a registration receiving message sent by the core network device, where the registration receiving message includes information about a first registration area allocated to the terminal device and second network slice information, the second network slice information is information about a second network slice that is allowed to be accessed by the terminal device in the first registration area, and

the second network slice information includes the first network slice information.

In another possible implementation, the sending module 701 is configured to send a first message to a radio access network device, where the first message is used to obtain third network slice information of a third network slice supported by the radio access network device.

The receiving module 702 is configured to receive a second message sent by the radio access network device, where the second message includes the third network slice information.

Optionally, the first message may carry indication information, the indication information is used to obtain the third network slice information of the third network slice supported by the radio access network device, and the indication information is used to indicate information obtained through the first message.

Alternatively, optionally, the first message may carry a requested system information block identifier, the requested system information block identifier is used to obtain the third network slice information, and the requested system information block identifier is used to indicate information obtained through the first message.

Optionally, the first message is a radio resource control RRC system information request message, the second message is a system information message, and the system information message includes the third network slice information.

Optionally, the first message is a random access preamble message, and the second message is a system information message.

Optionally, the first message is a radio resource control RRC request message, and the second message is an RRC response message.

It may be understood that the terminal device 700 is configured to implement the operations performed by the terminal device in the embodiments in FIG. 2 to FIG. 6. For a specific implementation of the functional modules included in the terminal device in FIG. 7 and corresponding beneficial effects, refer to the specific descriptions of the embodiments in FIG. 2 to FIG. 6. Details are not described herein.

In this embodiment of this application, the sending module 701 may be a receiver or a receiving circuit, and the receiving module 702 may be a transmitter or a sending circuit. The sending module 701 and the receiving module 702 may alternatively be communication interfaces of the terminal device.

The terminal device 700 in the embodiment shown in FIG. 7 may be implemented by a terminal device 800 shown in FIG. 8. FIG. 8 is a schematic structural diagram of another terminal device according to an embodiment of this application. The terminal device 800 shown in FIG. 8 includes a processor 801 and a transceiver 802.

The transceiver 802 is configured to support information transmission between the terminal device 800 and the radio access network device or the core network device in the foregoing embodiments.

The processor 801 is configured to control and manage an action of the terminal device.

For example, in the embodiment shown in FIG. 2, the transceiver 802 is configured to: receive the message in operation 203 and send the message in operation 201 in the embodiment shown in FIG. 2. For example, in the embodiments shown in FIG. 3, FIG. 4, FIG. 5, and FIG. 6, the transceiver 802 is configured to: receive the message and send the message in the embodiment shown in FIG. 3. The processor 801 is configured to support the transceiver 802 in performing the foregoing operations.

The processor 801 and the transceiver 802 are in communication connection, for example, a bus 804. The bus 804 may be a PCI bus, an EISA bus, or the like. The bus 804 may be classified into an address bus, a data bus, a control bus, and the like. For ease of representation, only one thick line is used to represent the bus in FIG. 8, but this does not mean that there is only one bus or only one type of bus.

The terminal device 800 may further include a memory 803. The memory 803 is configured to store program code and data that are executed by the terminal device 800. The processor 801 is configured to execute the application program code stored in the memory 803, to implement an action of the terminal device provided in any one of the embodiments shown in FIG. 2 to FIG. 6.

It should be noted that, during actual application, the terminal device may include one or more processors, and a structure of the terminal device 800 does not constitute a limitation on this embodiment of this application.

The processor 801 may be a central processing unit (CPU), a general-purpose processor, a digital signal processor (DSP), an application-specific integrated circuit (ASIC), a field programmable gate array (FPGA) or another programmable logic device, a transistor logic device, a hardware component, or any combination thereof. The processor may implement or execute various example logical blocks, modules, and circuits described with reference to content disclosed in this application. Alternatively, the processor may be a combination of processors implementing a computing function, for example, a combination of one or more microprocessors, or a combination of a DSP and a microprocessor.

The transceiver 804 may be a communication interface, a transceiver circuit, or the like. The transceiver is a general term. During specific implementation, the transceiver may include a plurality of interfaces.

The memory 803 may include a volatile memory, for example, a random access memory (RAM). The memory 803 may also include a non-volatile memory, for example, a read-only memory (read-only memory, ROM), a flash memory, a hard disk drive (HDD), or a solid-state drive (SSD). The memory 803 may further include a combination of the foregoing types of memories.

An embodiment of this application further provides a readable storage medium, and the readable storage medium may be configured to store computer software instructions used by the terminal device in the embodiments shown in FIG. 2 to FIG. 6, to implement any one of the possible implementations of the embodiments shown in FIG. 2 to FIG. 6. The storage medium includes but is not limited to a flash memory, a hard disk drive, or a solid-state drive.

An embodiment of this application further provides a computer program product. When the computer product runs on a computing device, a communication method designed for the terminal device in the foregoing embodiments may be performed.

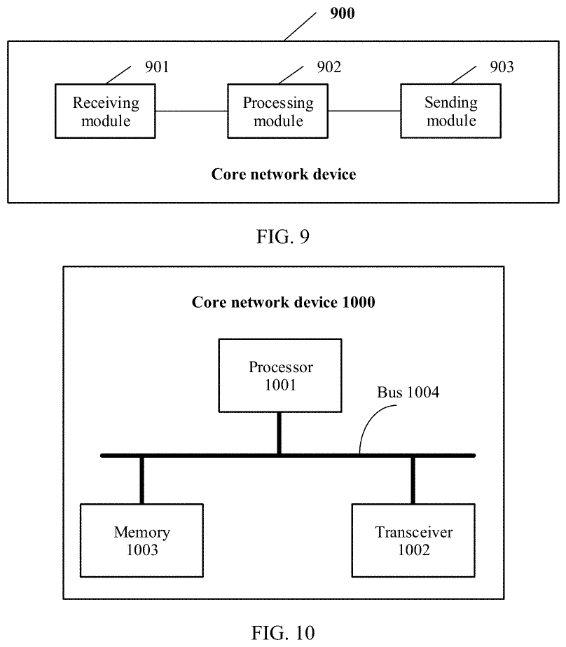

FIG. 9 is a schematic structural diagram of another core network device according to an embodiment of this application. As shown in FIG. 9, the core network device 900 includes a receiving module 901, a processing module 902, and a sending module 903.

The receiving module 901 is configured to receive, through a radio access network device, a registration request message sent by a terminal device, where the registration request message includes first network slice information, and the first network slice information is information about a first network slice corresponding to a PDU session that the terminal device expects to establish.

The processing module 902 is configured to allocate a first registration area to the terminal device based on the registration request message, where the first registration area supports at least a second network slice, and the second network slice is a network slice that is allowed to be accessed by the terminal device in the first registration area.

The sending module 903 is configured to send a registration receiving message to the terminal device through the radio access network device, where the registration receiving message includes information about the first registration area and second network slice information of the second network slice, and

the second network slice information includes the first network slice information.

It may be understood that the core network device 900 is configured to implement the operations performed by the core network device in the embodiments in FIG. 2 to FIG. 6. For a specific implementation of the functional modules included in the core network device in FIG. 9 and corresponding beneficial effects, refer to the specific descriptions of the embodiments in FIG. 2 to FIG. 6. Details are not described herein.

In this embodiment of this application, the receiving module 901 may be a receiver or a receiving circuit, and the sending module 903 may be a transmitter or a sending circuit. The receiving module 901 and the sending module 903 may alternatively be communication interfaces of the core network device. The processing module 902 may be a processor.

The core network device 900 shown in FIG. 9 may be implemented by a core network device 1000 shown in FIG. 10. FIG. 10 is a schematic structural diagram of another core network device according to an embodiment of this application. The core network device 1000 shown in FIG. 10 includes a processor 1001 and a transceiver 1002.

The transceiver 1002 is configured to support information transmission between the core network device 1000 and the terminal device in the foregoing embodiments, and the processor 1001 is configured to control and manage an action of the core network device 1000.

For example, in the embodiment shown in FIG. 2, the transceiver 1002 is configured to: send the message in operation 203 and receive the message in operation 201 in the embodiment shown in FIG. 2. The processing unit 1001 is configured to implement operation 202.

The processor 1001 and the transceiver 1002 are in communication connection, for example, a bus. The core network device 1000 may further include a memory 1003. The memory 1003 is configured to store program code and data that are executed by the core network device 1000. The processor 1001 is configured to execute the application program code stored in the memory 1003, to implement an action of the core network device provided in any one of the embodiments shown in FIG. 2 to FIG. 6.

It should be noted that, during actual application, the core network device may include one or more processors, and a structure of the core network device 1000 does not constitute a limitation on this embodiment of this application.

The processor 1001 may be a CPU, an NP, a hardware chip, or any combination thereof. The hardware chip may be an ASIC, a PLD, or a combination thereof. The PLD may be a CPLD, an FPGA, a GAL, or any combination thereof.

The memory 1003 may include a volatile memory, for example, a RAM. The memory 1003 may also include a non-volatile memory, for example, a ROM, a flash memory, a hard disk drive, or a solid-state drive. The memory 1003 may further include a combination of the foregoing types of memories.

An embodiment of this application further provides a readable storage medium, and the readable storage medium may be configured to store computer software instructions used by the core network device in the embodiments shown in FIG. 2 to FIG. 6, to implement any one of the possible implementations of the embodiments shown in FIG. 2 to FIG. 6. The storage medium includes but is not limited to a flash memory, a hard disk drive, or a solid-state drive.

An embodiment of this application further provides a computer program product. When the computer product runs on a computing device, a communication method designed for the core network device in the foregoing embodiments may be performed.

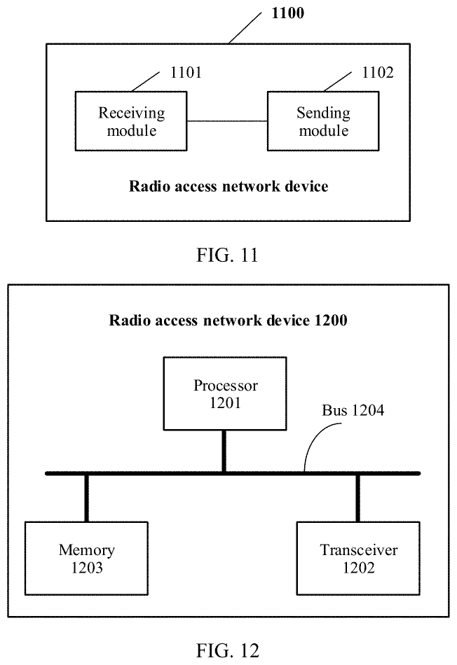

FIG. 11 is a schematic structural diagram of another radio access network device according to an embodiment of this application. As shown in FIG. 11, the radio access network device 1100 includes a receiving module 1101 and a sending module 1102.

The receiving module 1101 is configured to receive a first message sent by a terminal device, where the first message is used to obtain third network slice information of a third network slice supported by the radio access network device.

The sending module 1102 is configured to send a second message to the terminal device, where the second message includes the third network slice information.

Optionally, the first message may carry indication information, the indication information is used to obtain the third network slice information of the third network slice supported by the radio access network device, and the indication information is used to indicate information obtained through the first message.

Alternatively, optionally, the first message may carry a requested system information block identifier, the requested system information block identifier is used to obtain the third network slice information, and the requested system information block identifier is used to indicate information obtained through the first message.

Optionally, the first message is a radio resource control RRC system information request message, the second message is a system information message, and the system information message includes the third network slice information.

Optionally, the first message is a random access preamble message, and the second message is a system information message.

Optionally, the first message is a radio resource control RRC request message, and the second message is an RRC response message.

It may be understood that the radio access network device 1100 is configured to implement the operations performed by the radio access network device in the embodiments in FIG. 2 to FIG. 6. For a specific implementation of the functional modules included in the radio access network device in FIG. 11 and corresponding beneficial effects, refer to the specific descriptions of the embodiments in FIG. 2 to FIG. 6. Details are not described herein.

In this embodiment of this application, the receiving module 1101 may be a receiver or a receiving circuit, and the sending module 1102 may be a transmitter or a sending circuit. The receiving module 1101 and the sending module 1102 may alternatively be communication interfaces of the radio access network device.

The radio access network device 1100 shown in FIG. 11 may be implemented by a radio access network device 1200 shown in FIG. 12. FIG. 12 is a schematic structural diagram of another radio access network device according to an embodiment of this application. The radio access network device 1200 shown in FIG. 12 includes a processor 1201 and a transceiver 1202.

The transceiver 1202 is configured to support information transmission between the radio access network device 1200 and the terminal device in the foregoing embodiments, and the processor 1201 is configured to control and manage an action of the radio access network device 1200.

For example, in the embodiments shown in FIG. 3, FIG. 4, FIG. 5, and FIG. 6, the transceiver 1202 is configured to: receive the message and send the message in the embodiment shown in FIG. 3. The processing unit 1201 is configured to support the transceiver 1202 in performing the foregoing operations.

The processor 1201 and the transceiver 1202 are in communication connection, for example, a bus. The radio access network device 1200 may further include a memory 1203. The memory 1203 is configured to store program code and data that are executed by the radio access network device 1200. The processor 1201 is configured to execute the application program code stored in the memory 1203, to implement an action of the radio access network device provided in any one of the embodiments shown in FIG. 2 to FIG. 6.

It should be noted that, during actual application, the radio access network device may include one or more processors, and a structure of the radio access network device 1200 does not constitute a limitation on this embodiment of this application.

The processor 1201 may be a CPU, an NP, a hardware chip, or any combination thereof. The hardware chip may be an ASIC, a PLD, or a combination thereof. The PLD may be a CPLD, an FPGA, a GAL, or any combination thereof.

The memory 1203 may include a volatile memory, for example, a RAM. The memory 1203 may also include a non-volatile memory, for example, a ROM, a flash memory, a hard disk drive, or a solid-state drive. The memory 1203 may further include a combination of the foregoing types of memories.

An embodiment of this application further provides a readable storage medium, and the readable storage medium may be configured to store computer software instructions used by the radio access network device in the embodiments shown in FIG. 2 to FIG. 6, to implement any one of the possible implementations of the embodiments shown in FIG. 2 to FIG. 6. The storage medium includes but is not limited to a flash memory, a hard disk drive, or a solid-state drive.

An embodiment of this application further provides a computer program product. When the computer product runs on a computing device, a communication method designed for the radio access network device in the foregoing embodiments may be performed.

In the specification, claims, and accompanying drawings of this application, the terms “first”, “second”, “third”, “fourth”, and the like are intended to distinguish between different objects but do not indicate a particular order. In addition, the terms “including”, “having”, and any other variant thereof are intended to cover non-exclusive inclusion. For example, a process, method, system, product, or device that includes a series of operations or units is not limited to the listed operations or units, but optionally further includes an unlisted operation or unit, or optionally further includes another inherent operation or unit of the process, method, product, or device.

In this application, “A and/or B” refers to one of the following cases: A, B, and A and B. “At least one of refers to the listed items or any combination of any quantity of the listed items. For example, “at least one of A, B, and C” refers to one of the following cases: any one of the seven cases: A, B, C, A and B, B and C, A and C, and A, B, and C.

A person of ordinary skill in the art may understand that sequence numbers of the foregoing processes do not mean execution sequences in various embodiments of this application. The execution sequences of the processes should be determined based on functions and internal logic of the processes, and should not constitute any limitation on the implementation processes of the embodiments of this application.

All or some of the foregoing embodiments may be implemented by using software, hardware, firmware, or any combination thereof. When the embodiments are implemented by using the software, all or some of the embodiments may be implemented in a form of a computer program product. The computer program product includes one or more computer instructions. When the computer instructions are loaded and executed on a computer, the procedures or functions according to the embodiments of this application are all or partially generated. The computer may be a general-purpose computer, a special-purpose computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk drive, or a magnetic tape), an optical medium (for example, a DVD), a semiconductor medium (for example, a solid-state drive (SSD)), or the like.

A person of ordinary skill in the art may understand that all or some of the processes of the methods in the embodiments may be completed by a computer program instructing relevant hardware. The program may be stored in a computer-readable storage medium. When the program is executed, the processes of the methods in the embodiments may be included.

What is claimed is:

1. A communication method, comprising:
sending, by a terminal device, a registration request message to a core network device through a radio access network device, wherein the registration request message comprises first network slice information, and the first network slice information is information about a first network slice corresponding to a protocol data unit (PDU) session that the terminal device expects to establish; and
receiving, by the terminal device through the radio access network device, a registration accept message sent by the core network device, wherein the registration accept message comprises information about a first registration area allocated to the terminal device and second network slice information, the second network slice information is information about a second network slice that is allowed to be used by the terminal device in the first registration area, and
the second network slice information comprises the first network slice information.

2. The method according to claim 1, wherein the registration request message further comprises slice availability information, and the slice availability information comprises information about whether the first network slice is available in a tracking area comprised in a historically allocated second registration area.

3. The method according to claim 1, wherein the first network slice is a network slice that corresponds to the PDU session that the terminal device expects to establish and that is supported by the radio access network device.

4. The method according to claim 3, wherein before the sending, by a terminal device, a registration request message to a core network device, the method further comprises:
sending, by the terminal device, a first message to the radio access network device, wherein the first message is used to obtain third network slice information of a third network slice supported by the radio access network device; and
receiving, by the terminal device, a second message sent by the radio access network device, wherein the second message comprises the third network slice information.

5. The method according to claim 4, wherein
the first message is a radio resource control RRC system information request message, the second message is a system information message, and the system information message comprises the third network slice information.

6. The method according to claim 4, wherein
the first message is a random access preamble message, and the second message is a system information message.

7. The method according to claim 4, wherein
the first message is a radio resource control RRC request message, and the second message is an RRC response message.

8. The method according to claim 5, wherein the first message comprises a requested system information block identifier or indication information, the requested system information block identifier is used to obtain the third network slice information, and the indication information is used to obtain the third network slice information.

9. The method according to claim 7, wherein the first message comprises indication information, and the indication information is used to obtain the third network slice information.

10. A communication method, comprising:
receiving, by a core network device through a radio access network device, a registration request message sent by a terminal device, wherein the registration request message comprises first network slice information, and the first network slice information is information about a first network slice corresponding to a protocol data unit (PDU) session that the terminal device expects to establish;
allocating, by the core network device, a first registration area to the terminal device based on the registration request message, wherein the first registration area supports at least a second network slice, and the second network slice is a network slice that is allowed to be used by the terminal device in the first registration area; and
sending, by the core network device, a registration accept message to the terminal device through the radio access network device, wherein the registration accept message comprises information about the first registration area and second network slice information of the second network slice, and
the second network slice information comprises the first network slice information.

11. The method according to claim 10, wherein the first registration area comprises at least one tracking area, each of the at least one tracking area supports the first network slice, and the at least one tracking area is determined based on a network slice supported by each of a plurality of tracking areas and the first network slice information.

12. The method according to claim 10, wherein the registration request message further comprises slice availability information, and the slice availability information comprises information about whether the first network slice is available in a tracking area comprised in a historically allocated second registration area.

13. The method according to claim 12, wherein the first registration area consists of at least one tracking area, each of the at least one tracking area supports the first network slice, and the at least one tracking area is determined based on the slice availability information and the first network slice information.

14. The method according to claim 10, wherein the first network slice is a network slice that corresponds to the PDU session that the terminal device expects to establish and that is supported by the radio access network device.

15. A terminal device, comprising:
a sending module, configured to send a registration request message to a core network device through a radio access network device, wherein the registration request message comprises first network slice information, and the first network slice information is information about a first network slice corresponding to a protocol data unit (PDU) session that the terminal device expects to establish; and
a receiving module, configured to receive, through the radio access network device, a registration receiving message sent by the core network device, wherein the registration accept message comprises information about a first registration area allocated to the terminal device and second network slice information, the second network slice information is information about a second network slice that is allowed to be used by the terminal device in the first registration area, and
the second network slice information comprises the first network slice information.

16. The terminal device according to claim 15, wherein the registration request message further comprises slice availability information, and the slice availability information comprises information about whether the first network slice is available in a tracking area comprised in a historically allocated second registration area.

17. The terminal device according to claim 15, wherein the first network slice is a network slice that corresponds to the PDU session that the terminal device expects to establish and that is supported by the radio access network device.

18. The terminal device according to claim 17, wherein before the sending module sends the registration request message to the core network device,
the sending module is further configured to send a first message to the radio access network device, wherein the first message is used to obtain third network slice information of a third network slice supported by the radio access network device; and
the receiving module is further configured to receive a second message sent by the radio access network device, wherein the second message comprises the third network slice information.

19. The terminal device according to claim 18, wherein
the first message is a radio resource control RRC system information request message, the second message is a system information message, and the system information message comprises the third network slice information.

20. The terminal device according to claim 18, wherein
the first message is a random access preamble message, and the second message is a system information message.

21. The terminal device according to claim 18, wherein
the first message is a radio resource control RRC request message, and the second message is an RRC response message.

22. The terminal device according to claim 19, wherein the first message comprises a requested system information block identifier or indication information, the requested system information block identifier is used to obtain the third network slice information, and the indication information is used to obtain the third network slice information.

23. The terminal device according to claim 21, wherein the first message comprises indication information, and the indication information is used to obtain the third network slice information.

24. A core network device, comprising:
a receiving module, configured to receive a registration request message sent by a terminal device, wherein the registration request message comprises first network slice information, and the first network slice information is information about a first network slice corresponding to a protocol data unit (PDU) session that the terminal device expects to establish;
a processing module, configured to allocate a first registration area to the terminal device based on the registration request message, wherein the first registration area supports at least a second network slice, and the second network slice is a network slice that is allowed to be used by the terminal device in the first registration area; and
a sending module, configured to send a registration accept message to the terminal device, wherein the registration accept message comprises information about the first registration area and second network slice information of the second network slice, and
the second network slice information comprises the first network slice information.

25. The core network device according to claim 24, wherein the first registration area consists of at least one tracking area, each of the at least one tracking area supports the first network slice, and the at least one tracking area is determined based on a network slice supported by each of a plurality of tracking areas and the first network slice information.

26. The core network device according to claim 24, wherein the registration request message further comprises slice availability information, and the slice availability information comprises information about whether the first network slice is available in a tracking area comprised in a historically allocated second registration area.

27. The core network device according to claim 26, wherein the first registration area consists of at least one tracking area, each of the at least one tracking area supports the first network slice, and the at least one tracking area is determined based on the slice availability information and the first network slice information.

28. The core network device according to claim 24, wherein the first network slice is a network slice that corresponds to the PDU session that the terminal device expects to establish and that is supported by the radio access network device.
